(19) United States
(12) Patent Application Publication
(10) Pub. No.: US 2022/0206140 A1
(43) Pub. Date: Jun. 30, 2022

(54) INCREASED RADAR ANGULAR RESOLUTION WITH EXTENDED APERTURE FROM MOTION

(71) Applicant: GM GLOBAL TECHNOLOGY OPERATIONS LLC, Detroit, MI (US)

(72) Inventors: Oded Bialer, Petah Tivak (IL); Amnon Jonas, Jerusalem (IL)

(21) Appl. No.: 17/136,452

(22) Filed: Dec. 29, 2020

(51) Int. Cl. G01S 13/90; G01S 7/41; G01S 13/931

(52) U.S. Cl. CPC G01S 13/9027; G01S 7/417; G01S 2013/93271; G01S 13/931; G01S 7/411

(57) ABSTRACT

A vehicle and a system and method of operating the vehicle. The system includes an extended radar array, a processor and a controller. The extended radar array is formed by moving a radar array of the vehicle through a selected distance. The processor is configured to receive a plurality of observations of an object from the extended radar array, operate a neural network to generate a network output signal based on the plurality of observations, and determine an object parameter of the object with respect to the vehicle from the network output signal. The controller operates the vehicle based on the object parameter of the object.

### INTRODUCTION

The subject disclosure relates to vehicular radar systems and, in particular, to a system and method for increasing an angular resolution of a vehicular radar array using a motion of the vehicle.

An autonomous vehicle can navigate with respect to an object in its environment by detecting the object and determining a trajectory that avoids the object. Detection can be performed by various detection systems, one of which is a radar system employing one or more radar antennae. An angular resolution of a radar antenna is limited due to its aperture size, which is generally a few centimeters. The angular resolution can be increased by using an array of antennae spanning a wider aperture. However, the dimension of the vehicle limits the dimension of the antenna array, thereby limiting its angular resolution. Accordingly, it is desirable to provide a system and method for operating an antenna array of a vehicle that extends its angular resolution beyond the limits imposed by the dimensions of the vehicle.

### SUMMARY

In one exemplary embodiment, a method of operating a vehicle is disclosed. A plurality of observations of an object are received at an extended radar array formed by moving a radar array of the vehicle through a selected distance. The plurality of observations is input to a neural network to generate a network output signal. An object parameter of the object with respect to the vehicle is determined from the network output signal. The vehicle is operated based on the object parameter of the object.

In addition to one or more of the features described herein, the method further includes obtaining the plurality of observations at each of a plurality of locations of the radar array as the radar array moves through the selected distance. The method further includes inputting the plurality of observations to the neural network to generate a plurality of features and combining the plurality of features to obtain the network output signal. The neural network includes a plurality of convolution networks, each convolution network receiving a respective observation from the plurality of observations and generating a respective feature of the plurality of features. The method further includes training the neural network by determining values of weights of the neural network that minimize a loss function including the network output signal and a reference signal. The reference signal is generated by coherently combining the plurality of observations over time based on a known relative distance between the radar array and the object during a relative motion between the vehicle and the object. The reference signal includes a product of an observation received from the extended radar array and a synthetic response based on angles and ranges recorded for the observation.

In another exemplary embodiment, a system for operating a vehicle is disclosed. The system includes an extended radar array, a processor and a controller. The extended radar array is formed by moving a radar array of the vehicle through a selected distance. The processor is configured to receive a plurality of observations of an object from the extended radar array, operate a neural network to generate a network output signal based on the plurality of observations, and determine an object parameter of the object with respect to the vehicle from the network output signal. The controller operates the vehicle based on the object parameter of the object.

In addition to one or more of the features described herein, the extended radar array obtains the plurality of observations at each of a plurality of locations of the radar array as the radar array moves through the selected distance. The processor is further configured to operate the neural network to generate a plurality of features based on the plurality of observations and to operate a concatenation module to combine the plurality of features to obtain the network output signal. The neural network includes a plurality of convolution networks, each convolution network configured to receive a respective observation from the plurality of observations and generate a respective feature of the plurality of features. The processor is further configured to train the neural network by determining values of weights of the neural network that minimize a loss function including the network output signal and a reference signal. The processor is further configured to generate the reference signal by coherently combining the plurality of observations over time based on a known relative distance between the radar array and the object during a relative motion between the vehicle and the object. The processor is further configured to generate the reference signal from a product of an observation received from the extended radar array and a synthetic response based on angles and ranges recorded for the observation.

In yet another exemplary embodiment, a vehicle is disclosed. The vehicle includes an extended radar array, a processor and a controller. The extended radar array is formed by moving a radar array of the vehicle through a selected distance. The processor is configured to receive a plurality of observations of an object from the extended radar array, operate a neural network to generate a network output signal, and determine an object parameter of the object with respect to the vehicle from the network output signal. The controller operates the vehicle based on the object parameter of the object.

In addition to one or more of the features described herein, the extended radar array obtains the plurality of observations at each of a plurality of locations of the radar array as the radar array moves through the selected distance. The processor is further configured to operate the neural network to generate a plurality of features based on inputting the plurality of observations and operate a concatenation module to combine the plurality of features to obtain the network output signal. The processor is further configured to train the neural network by determining values of weights of the neural network that minimize a loss function including the network output signal and a reference signal. The processor is further configured to generate the reference signal by coherently combining the plurality of observations over time based on a known relative distance between the radar array and the object during a relative motion between the vehicle and the object. The processor is further configured to generate the reference signal from a product of an observation received from the extended radar array and a synthetic response based on angles and ranges recorded for the observation.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an autonomous vehicle in an embodiment;

FIG. 2 shows the autonomous vehicle of FIG. 1 including a radar array of the radar system suitable for detecting objects within its environment;

FIG. 3 shows an extended radar array generated by moving the radar array of FIG. 2 through a selected distance;

FIG. 4 shows a schematic diagram illustrating side-to-side motion as the autonomous vehicle moves forward to generate the extended radar array;

FIG. 5 shows a schematic diagram illustrating a method of training a neural network to determine an angular location with a resolution that is insensitive to the lateral or side-to-side motion of the vehicle;

FIG. 6 shows a block diagram illustrating a method for training a deep neural network, according to an embodiment;

FIG. 7 shows a neural network architecture corresponding to a feature generation process of FIG. 6;

FIG. 8 shows a block diagram illustrating a method for using the trained deep neural network in order to determine an angular location of an object;

FIG. 9 shows a graph of angular resolutions obtained using the methods disclosed herein; and

FIG. 10 shows a top-down view of the autonomous vehicle illustrating angular resolutions of the three-radar array at various angles with respect to vehicle.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

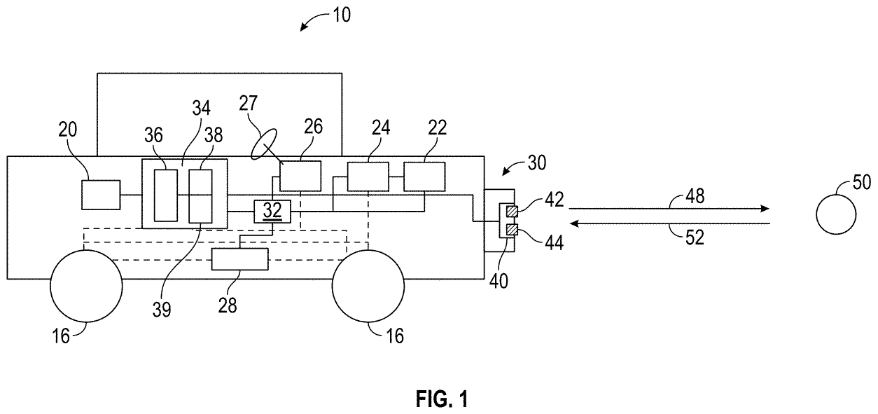

In accordance with an exemplary embodiment, FIG. 1 shows an autonomous vehicle 10. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. It is to be understood that the system and methods disclosed herein can also be used with an autonomous vehicle operating at any of the levels 1 through 5.

The autonomous vehicle 10 generally includes at least a navigation system 20, a propulsion system 22, a transmission system 24, a steering system 26, a brake system 28, a sensor system 30, an actuator system 32, and a controller 34. The navigation system 20 determines a trajectory plan for automated driving of the autonomous vehicle 10. The propulsion system 22 provides power for creating a motive force for the autonomous vehicle 10 and can, in various embodiments, include an internal combustion engine, an electric machine such as a traction motor, and/or a fuel cell propulsion system. The transmission system 24 is configured to transmit power from the propulsion system 22 to two or more wheels 16 of the autonomous vehicle 10 according to selectable speed ratios. The steering system 26 influences a position of the two or more wheels 16. While depicted as including a steering wheel 27 for illustrative purposes, in some embodiments contemplated within the scope of the present disclosure, the steering system 26 may not include a steering wheel 27. The brake system 28 is configured to provide braking torque to the two or more wheels 16.

The sensor system 30 includes a radar system 40 that senses objects in an exterior environment of the autonomous vehicle 10 and provides various radar parameters of the objects useful in determining object parameters of the one or more objects 50, such as the position and relative velocities of various remote vehicles in the environment of the autonomous vehicle. Such radar parameters can be provided to the navigation system 20. In operation, the transmitter 42 of the radar system 40 sends out a radio frequency (RF) source signal 48 that is reflected back at the autonomous vehicle 10 by one or more objects 50 in the field of view of the radar system 40 as one or more reflected echo signals 52, which are received at receiver 44. The one or more echo signals 52 can be used to determine various object parameters of the one or more objects 50, such as a range of the object, Doppler frequency or relative radial velocity of the object, and azimuth, etc. The sensor system 30 includes additional sensors, such as digital cameras, for identifying road features, etc.

The navigation system 20 builds a trajectory for the autonomous vehicle 10 based on radar parameters from the radar system 40 and any other relevant parameters. The controller 34 can provide the trajectory to the actuator system 32 to control the propulsion system 22, transmission system 24, steering system 26, and/or brake system 28 in order to navigate the autonomous vehicle 10 with respect to the object 50.

The controller 34 includes a processor 36 and a computer readable storage device or computer-readable storage medium 38. The computer readable storage medium includes programs or instructions 39 that, when executed by the processor 36, operate the autonomous vehicle based at least on radar parameters and other relevant data. The computer-readable storage medium 38 may further include programs or instructions 39 that when executed by the processor 36, determines a state of object 50 in order to allow the autonomous vehicle to drive with respect the object.

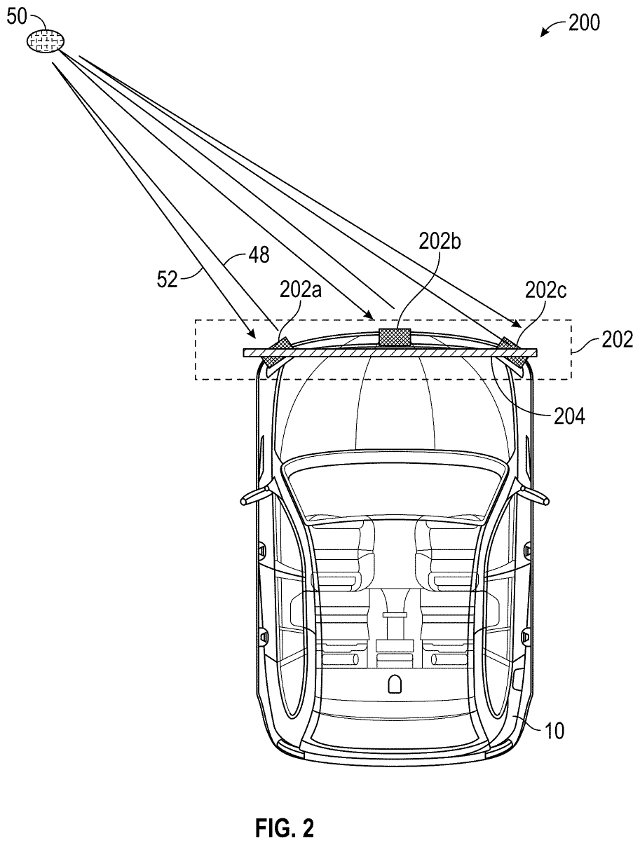

FIG. 2 shows a plan view 200 of the autonomous vehicle 10 of FIG. 1 including a radar array 202 of the radar system 40 suitable for detecting objects within its environment. The radar array 202 includes individual radars (202a, 202b, 202c) disposed along a front end of the autonomous vehicle 10. The radar array 202 can be at any selected location of the autonomous vehicle 10 in various embodiments. The radar array 202 is operated in order to generate a source signal 48 and receive, in response, an echo signal 52 by reflection of the source signal from an object, such as object 50. The radar system 40 can operate the radar array 202 to perform beam steering of the source signal. A comparison of the echo signal and the source signal yields information about object parameters of the object 50 such as its range, azimuthal location, elevation and relative radial velocity with respect to the autonomous vehicle 10. Although the radar array 202 is shown having three radars (202a, 202b, 202c), this is only of illustrative purposes and is not meant as a limitation.

The radars (202a, 202b, 202c) are substantially aligned along a baseline 204 of the radar array 202. A length of the baseline 204 is defined by a distance from one end of the radar array 202 to an opposite end of the radar array. Although the baseline 204 can be a straight, in other embodiments, the radars (202a, 202b, 202c) are located along a baseline that is a curved surface such as a front surface of the autonomous vehicle 10.

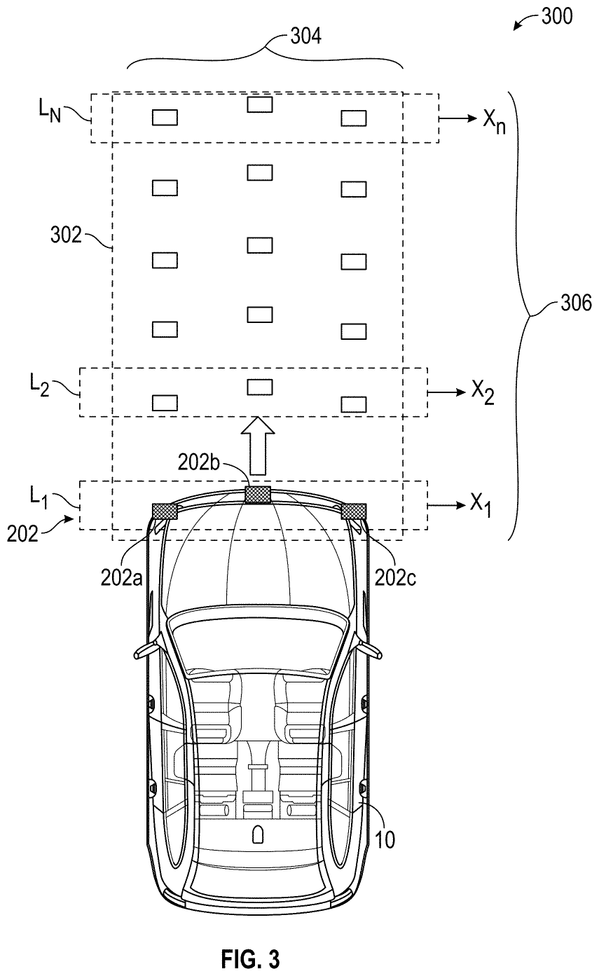

FIG. 3 shows a plan view 300 of the autonomous vehicle 10 moving the radar array 202 of FIG. 2 through a selected distance to form an extended radar array 302. In various embodiments, the radar array 202 is moved in a direction perpendicular to or substantially perpendicular to the baseline 204. Radar observations (X₁, . . . , Xₙ) are obtained at various times during the motion through the selected distance, resulting in echo signals being detected with the radar array at the various radar array locations (L₁, . . . , Lₙ) shown in FIG. 3. Forward movement of the autonomous vehicle 10 generates a two-dimensional extended radar array 302. A forward aperture 304 of the extended radar array 302 is defined by the length of the baseline 204 of the radar array 200. A side aperture 306 of the extended radar array 302 is defined by a distance that the autonomous vehicle 10 moves within a selected time.

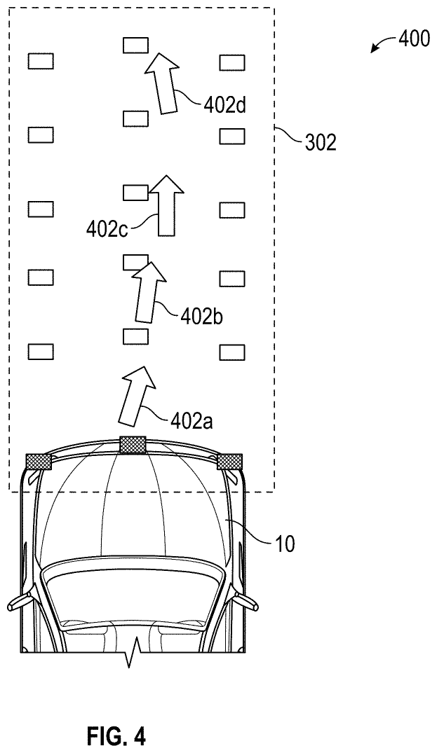

FIG. 4 shows a schematic diagram 400 illustrating side-to-side motion as the autonomous vehicle 10 moves forward to generate the extended radar array. Velocity vectors 402a, 402b, 402c and 402d shown for the autonomous vehicle 10 reveal that even as the vehicle moves in a “straight ahead” direction, there exists a lateral component of velocity due to side-to-side motion. The angular resolution of the extended radar array 302 resulting from forward motion of the vehicle is sensitive to this side-to-side motion.

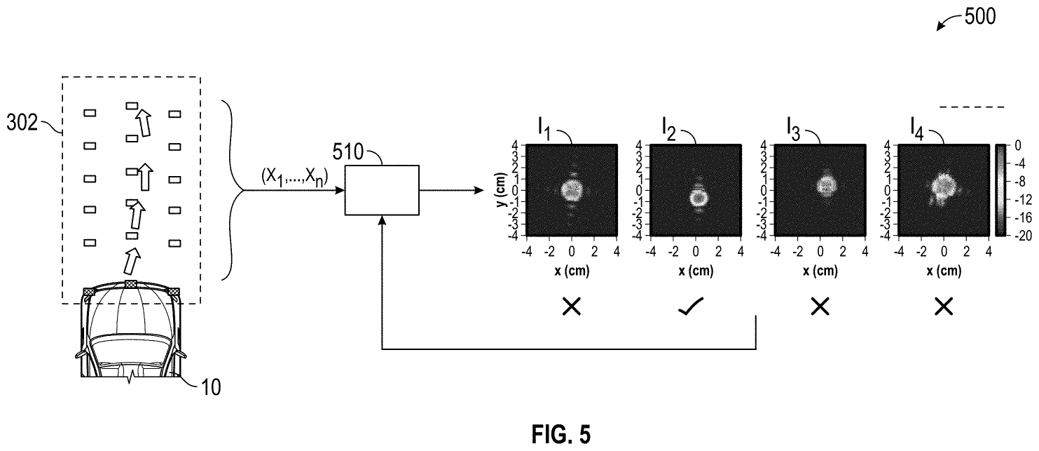

FIG. 5 shows a schematic diagram 500 illustrating a method of training a neural network to determine an angular location with a resolution that is insensitive to the lateral or side-to-side motion of the autonomous vehicle 10. A training stage for the neural network uses ground truth knowledge concerning relative distances between the radar array 202 and the object 50 during a relative motion between the radar array and the object. The observations (X₁, . . . , Xₙ) recorded by the extended radar array 302 are sent to a neural network such as Deep Neural Network (DNN) 510. The DNN 510 outputs Intensity images (I₁, . . . , Iₙ) from which the various object parameters of the object, such as the angular location of the object, range, etc., can be determined. Intensity images (I₁, . . . , Iₙ) for each of the observations (X₁, . . . , Xₙ), respectively, are shown in a region defined by range (x) and cross-range (y) coordinates, which are related to angular location. These intensity images (I₁, . . . , Iₙ) can be compared to ground truth images to update weights and coefficient of the DNN 510, thereby training the DNN 510 for later use in an inference stage of operation. The intensity peaks of the intensity images (I₁, . . . , Iₙ) appear at different locations within the region. For example, the intensity peak in intensity image 12 is at a closer range than the peaks in the other intensity images, while being substantially at the same cross-range. The trained DNN 510 is able to determine an angular position of an object with an increased angular resolution over the angular resolution of the radars of the radar array.

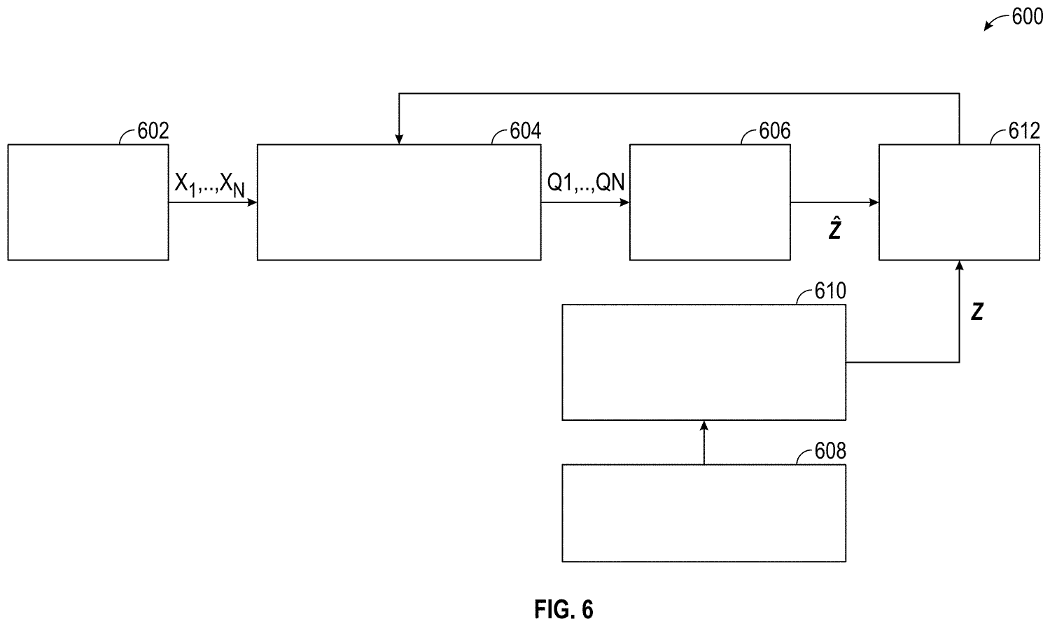

FIG. 6 shows a block diagram 600 illustrating a method for training a the DNN 510 according to an embodiment. In box 602, observations (X₁, . . . , X_{N}) are obtained at times (T₁, . . . , T_{N}). In box 604, the DNN 510 processes each observation (X₁, . . . , X_{N}) independently and generates a set of features (Q₁, . . . , Q_{N}) from the observations (X₁, . . . , X_{N}). In box 606, the network combines the features (Q₁, . . . , Q_{N}) to generate a network output signal \hat{Z}, which is a coherently combined reflection intensity image.

Meanwhile, in box 608, the radar array positions (L₁, . . . , L_{N}) at each observation (X₁, . . . , X_{N}) are recorded. In box 610, the observations (X₁, . . . , X_{N}) are coherently combined given the radar array positions for each observation. The combined observations generate a reference signal Z, as shown in Eq. (1):

Z=∥Σₙ₌₁^{N}a^{H}(θₙ,ϕₙ,Rₙ)Xₙ∥ Eq. (1)

where a^{H}(θₙ, ϕₙ, Rₙ) is an array of synthetic responses based on angles and ranges recorded for the n^{th} observation and Xₙ is the n^{th} observation received from the extended radar array.

In box 612, a loss is calculated using a loss function based on the network output signal \hat{Z} and the reference signal Z as disclosed below in Eq. (2).

loss=E{∥\hat{Z}−Z∥^{p}} Eq. (2)

where p is a value between 0.5 and 2, E represents an averaging operator over a set of examples (e.g., a training set). Therefore, the loss is an average over differences between the network output signal \hat{Z} and the reference signal Z. The loss calculated in box 612 is used at box 604 to update weights and coefficients of the neural network. Updating the weights and coefficients includes determining values of the weights and coefficients of the neural network that minimize the loss function or minimize the difference between the network output signal \hat{Z} and the reference signal Z.

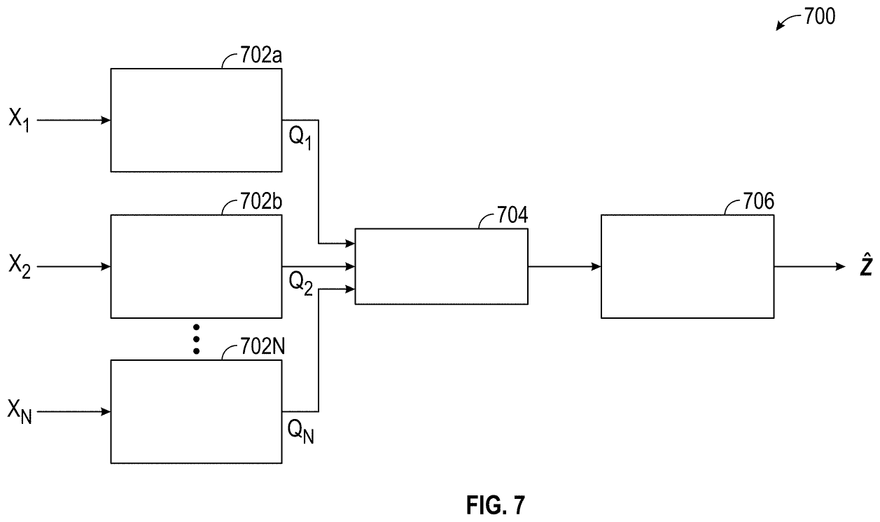

FIG. 7 shows a neural network architecture 700 corresponding to a feature generation process (i.e., box 604 and box 606 of the block diagram 600) of FIG. 6. The neural network architecture includes a plurality of convolution neural networks (CNNs) 702a, . . . 702N. Each CNN 702a receives an observation (X₁, . . . , X_{N}) and generates one or more features (Q₁, . . . , Q_{N}) from the observation. As shown in FIG. 7, CNN 702a receives observation X₁ and generates feature Q₁, CNN 702b receives observation X₂ and generates feature Q₂, and CNN 702n receives observation X_{N} and generates feature Q_{N}. A concatenation module 704 concatenates the features (Q₁, . . . , Q_{N}). The concatenated features are sent though a CNN 706 which generates the network signal \hat{Z} including a focused radar images with an enhanced resolution.

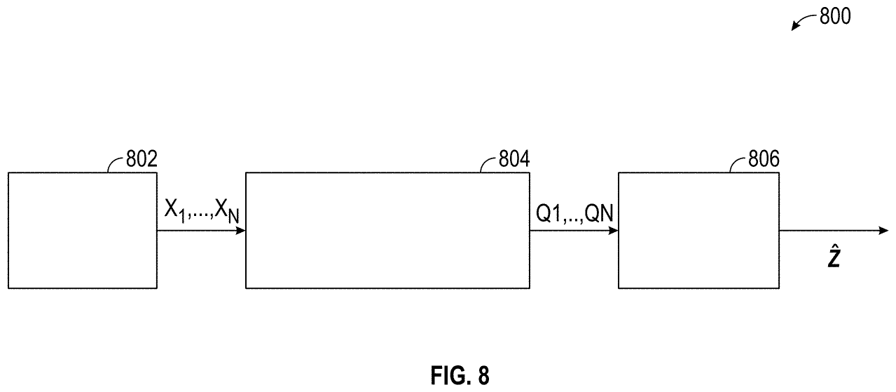

FIG. 8 shows a block diagram 800 illustrating a method for using the trained DNN 510 in order to determine an angular location of an object. In block 802, antenna array observations (X₁, . . . , X_{N}) are obtained at times (T₁, . . . , T_{N}). In block 804, the trained DNN 510 processes each observation (X₁, . . . , X_{N}) independently and generates a set of features (Q₁, . . . , Q_{N}) from the observation (X₁, . . . , X_{N}). In block 806, the features (Q₁, Q_{N}) are combined using a coherent matching filtering and the combination is processed via a trained CNN to generates the network output signal \hat{Z}.

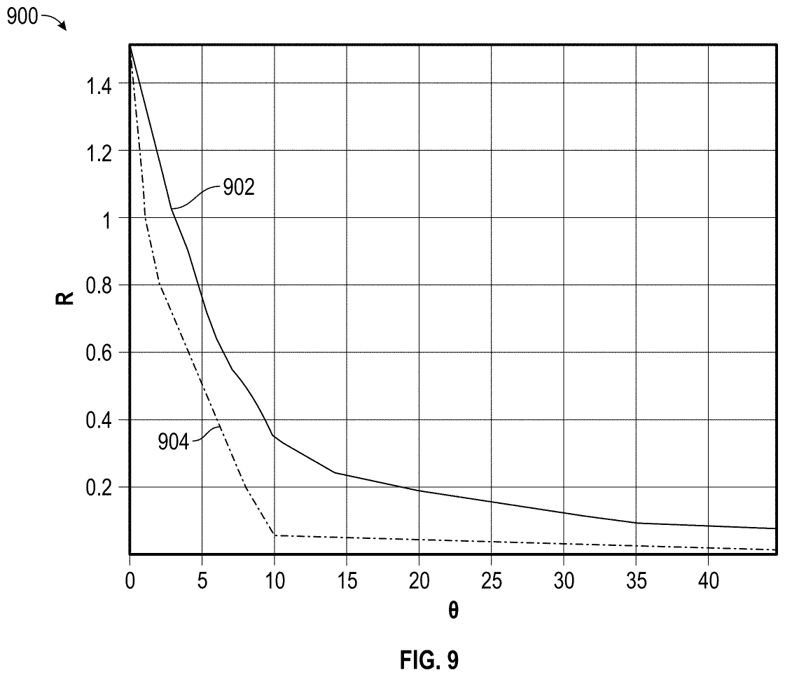

FIG. 9 shows a graph of angular resolutions obtained using the methods disclosed herein. Results are from an autonomous vehicle 10 with three radars (202a, 202b, 202c) moving at a rate sufficient to produce a 5-meter side aperture. Each radar includes an antenna array, each antenna array having an angular resolution of 1.5 degrees when run independently of the methods disclosed herein. The azimuth angle (θ) of the object is shown along the abscissa with zero degrees referring to the direction directly in front of the vehicle and 90 degrees off to a side of the vehicle. The angular resolution (R) is shown along the ordinate axis. By using a single radar (e.g., radar 202a) through a plurality of observations (X₁, . . . , X_{N}), the radar 202a can achieve an angular resolution shown in curve 902. For objects in front of the vehicle (zero degrees), the resolution for the single radar is the same as the standard resolution for the single radar (e.g., 1.5 degrees) as shown by curve 902 at 0 degrees. As the object angle increases, the angular resolution for the single radar drops, such that at 10 degrees from the front of the vehicle, the angular resolution for the single radar has improved to about 0.4 degrees. At higher object angles, the angular resolution for the single radar steadily improves, such that an angular resolution at 45 degrees is about 0.1 degrees.

Curve 904 shows an angular resolution for an extended radar array 302 based on the radar array 202 having three radars (202a, 202b, 202c). For objects in front of the vehicle (zero degrees), the resolution is the same as that of an individual antenna (e.g., 1.5 degrees) of the antenna array, as shown by curve 904. As the object angle increases, the angular resolution of the radar array 202 drops, such that at 10 degrees from the front of the vehicle, the angular resolution has improved to about 0.1 degrees. At higher object angles, the angular resolution of the radar array 202 steadily improves, such that an angular resolution at 45 degrees is about 0.02 degrees.

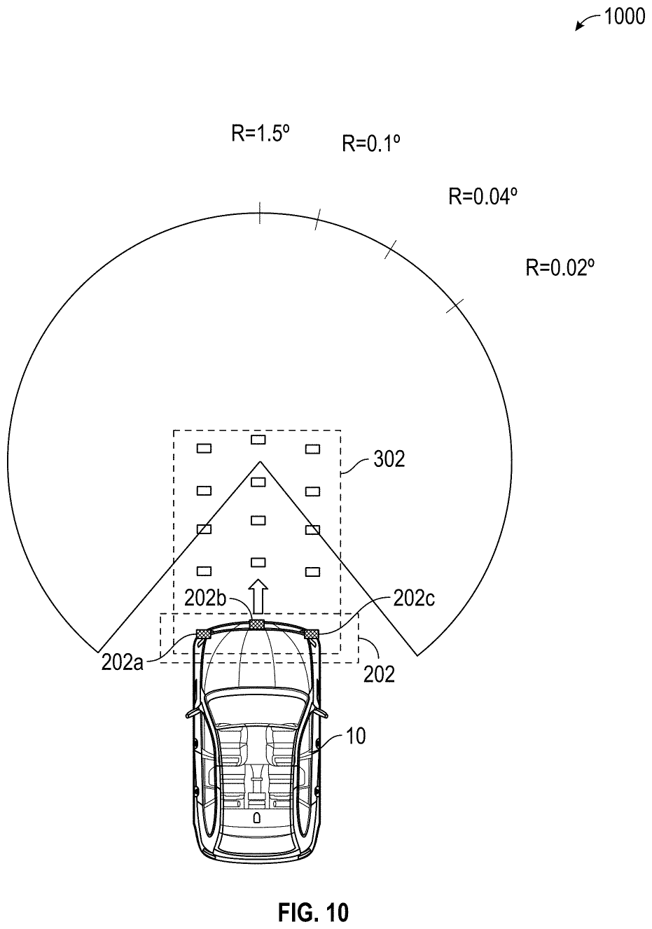

FIG. 10 shows a top-down view 1000 of the autonomous vehicle 10 illustrating angular resolutions of the radar array 202 having three radars (202a, 202b, 202c) at various angles with respect to vehicle. The angular resolution at zero degrees is 1.5 degrees. The angular resolution at 10 degrees is 0.1 degrees. The angular resolution at 25 degrees is 0.04 degrees. The angular resolution at 45 degrees is 0.02 degrees.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of operating a vehicle, comprising:
receiving a plurality of observations of an object at an extended radar array formed by moving a radar array of the vehicle through a selected distance;
inputting the plurality of observations to a neural network to generate a network output signal;
determining an object parameter of the object with respect to the vehicle from the network output signal; and
operating the vehicle based on the object parameter of the object.

2. The method of claim 1, further comprising obtaining the plurality of observations at each of a plurality of locations of the radar array as the radar array moves through the selected distance.

3. The method of claim 1, further comprising inputting the plurality of observations to the neural network to generate a plurality of features and combining the plurality of features to obtain the network output signal.

4. The method of claim 3, wherein the neural network includes a plurality of convolution networks, each convolution network receiving a respective observation from the plurality of observations and generating a respective feature of the plurality of features.

5. The method of claim 3, further comprising training the neural network by determining values of weights of the neural network that minimize a loss function including the network output signal and a reference signal.

6. The method of claim 5, wherein the reference signal is generated by coherently combining the plurality of observations over time based on a known relative distance between the radar array and the object during a relative motion between the vehicle and the object.

7. The method of claim 5, wherein the reference signal includes a product of an observation received from the extended radar array and a synthetic response based on angles and ranges recorded for the observation.

8. A system for operating a vehicle, comprising:
an extended radar array formed by moving a radar array of the vehicle through a selected distance;
a processor configured to:
receive a plurality of observations of an object from the extended radar array;
operate a neural network to generate a network output signal based on the plurality of observations;
determine an object parameter of the object with respect to the vehicle from the network output signal; and
a controller for operating the vehicle based on the object parameter of the object.

9. The system of claim 8, wherein the extended radar array obtains the plurality of observations at each of a plurality of locations of the radar array as the radar array moves through the selected distance.

10. The system of claim 8, wherein the processor is further configured to operate the neural network to generate a plurality of features based on the plurality of observations and to operate a concatenation module to combine the plurality of features to obtain the network output signal.

11. The system of claim 10, wherein the neural network includes a plurality of convolution networks, each convolution network configured to receive a respective observation from the plurality of observations and generate a respective feature of the plurality of features.

12. The system of claim 10, wherein the processor is further configured to train the neural network by determining values of weights of the neural network that minimize a loss function including the network output signal and a reference signal.

13. The system of claim 12, wherein the processor is further configured to generate the reference signal by coherently combining the plurality of observations over time based on a known relative distance between the radar array and the object during a relative motion between the vehicle and the object.

14. The system of claim 12, wherein the processor is further configured to generate the reference signal from a product of an observation received from the extended radar array and a synthetic response based on angles and ranges recorded for the observation.

15. A vehicle, comprising:
an extended radar array formed by moving a radar array of the vehicle through a selected distance;
a processor configured to:
receive a plurality of observations of an object from the extended radar array;
operate a neural network to generate a network output signal;
determine an object parameter of the object with respect to the vehicle from the network output signal; and
a controller for operating the vehicle based on the object parameter of the object.

16. The vehicle of claim 15, wherein the extended radar array obtains the plurality of observations at each of a plurality of locations of the radar array as the radar array moves through the selected distance.

17. The vehicle of claim 15, wherein the processor is further configured to operate the neural network to generate a plurality of features based on inputting the plurality of observations, and operate a concatenation module to combine the plurality of features to obtain the network output signal.

18. The vehicle of claim 17, wherein the processor is further configured to train the neural network by determining values of weights of the neural network that minimize a loss function including the network output signal and a reference signal.

19. The vehicle of claim 18, wherein the processor is further configured to generate the reference signal by coherently combining the plurality of observations over time based on a known relative distance between the radar array and the object during a relative motion between the vehicle and the object.

20. The vehicle of claim 18, wherein the processor is further configured to generate the reference signal from a product of an observation received from the extended radar array and a synthetic response based on angles and ranges recorded for the observation.
